(19) United States
(12) Patent Application Publication
(10) Pub. No.: US 2015/0019604 A1
(43) Pub. Date: Jan. 15, 2015

(54) FUNCTION ACCELERATOR

(71) Applicant: TEXAS INSTRUMENTS DEUTSCHLAND GMBH, Freising (DE)

(72) Inventors: Horst Diewald, Freising (DE); Johann Zipperer, Unterschleissheim (DE)

(21) Appl. No.: 13/938,849

(22) Filed: Jul. 10, 2013

(51) Int. Cl. G06F 17/10

(52) U.S. Cl. CPC G06F 17/10
USPC 708/208; 708/200

(57) ABSTRACT

A circuit and method for accelerating function evaluation. In one embodiment, a processor includes a function accelerator unit configured to evaluate a mathematical function. The function accelerator unit includes a coefficient generator and a polynomial evaluator. The coefficient generator is configured to generate coefficients for a polynomial evaluated to produce a solution to the function. The coefficient generator varies values of the coefficients based on an input value at which the function is to be evaluated. The polynomial evaluator configured to apply the coefficients provided by the coefficient generator to evaluate the polynomial at the input value.

### BACKGROUND

Many computer applications require the evaluation of mathematical functions, such as trigonometric functions, exponential functions, root functions, etc. Evaluation of such mathematical functions is typically provided via a library of software routines executed by a processor.

### SUMMARY

Systems and methods for accelerating function evaluation are disclosed herein. In one embodiment, a processor includes a function accelerator unit configured to evaluate a mathematical function. The function accelerator unit includes a coefficient generator and a polynomial evaluator. The coefficient generator is configured to generate coefficients for a polynomial evaluated to produce a solution to the function. The coefficient generator varies values of the coefficients based on an input value at which the function is to be evaluated. The polynomial evaluator is configured to apply the coefficients provided by the coefficient generator to evaluate the polynomial at the input value.

In another embodiment, a method for accelerating function processing includes providing, to a hardware accelerator, a designation of a function to be evaluated, and an operand value at which the function is to be evaluated. Coefficients for a polynomial to be evaluated to produce a solution to the function are generated by the hardware accelerator. The coefficient values are varied based on the operand value. The coefficients are applied by the hardware accelerator to evaluate the polynomial at the operand value.

In a further embodiment, a function acceleration circuit includes a coefficient generator and a polynomial evaluator. The coefficient generator is configured to generate coefficients for a polynomial evaluated to produce a solution to a function. The coefficient generator varies values of the coefficients based on an input value at which the function is to be evaluated. The coefficient generator is also configured to determine a number of coefficients to be applied in the polynomial. The coefficient generator varies the number of coefficients based on the input value at which the function is to be evaluated. The coefficient generator is further configured to provide a scaling factor for use with at least one of the coefficients. The polynomial evaluator is configured to determine, based on the function, which terms of the polynomial are to be computed and which terms, between terms to be computed, are to be omitted; and to apply the coefficients and the scaling factor provided by the coefficient generator to evaluate the polynomial at the input value.

### BRIEF DESCRIPTION OF THE DRAWINGS

For a detailed description of various examples, reference will now be made to the accompanying drawings in which:

FIG. 1 shows a block diagram of a processor that includes a function accelerator in accordance with various embodiments;

FIG. 2 shows block diagram of a function accelerator in accordance with various embodiments;

FIG. 3 shows coefficient generation in a function accelerator in accordance with various embodiments;

FIG. 4 shows block diagram of a coefficient generator include multiple coefficient tables in accordance with various embodiments;

FIG. 5 shows use of various fields of a function input value in a function accelerator in accordance with various embodiments; and

FIG. 6 shows a flow diagram for a method for evaluating a function in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Processors generally include an arithmetic unit that provides addition and subtraction of integer values. Many processors also include multipliers capable of integer multiplication. Processor architectures directed to more math intensive processing may support floating point and/or fixed point numeric formats in addition to integer formats. Evaluation of complex functions, such as trigonometric functions, exponential functions, logarithmic functions, roots, etc. is generally performed via execution of software routines that apply the adder and/or multiplier of the processor as needed to evaluate the functions. Unfortunately, function evaluation via software can be slow and power inefficient.

Embodiments of the present disclosure include a function acceleration unit that reduces the time and/or energy required to estimate complex functions. The function acceleration unit employs polynomial estimation of the function, and determines the values of the coefficients of the polynomial, the number of coefficients to be applied, and other computational parameters based on the value of the operand at which the function is to be evaluated. Accordingly, embodiments may apply one set of coefficients if the operand value falls within a first range, and a different set of coefficients if the operand falls within a second range, etc. Embodiments may support any number of such ranges, and the ranges may be of different sizes. By varying the coefficient number and values based on the operand value, embodiments of the function acceleration unit disclosed herein are able to reduce the time and power needed to produce a result without loss of accuracy relative to conventional systems. Alternatively, embodiments may produce a more accurate result without increase in time and power relative to conventional solutions.

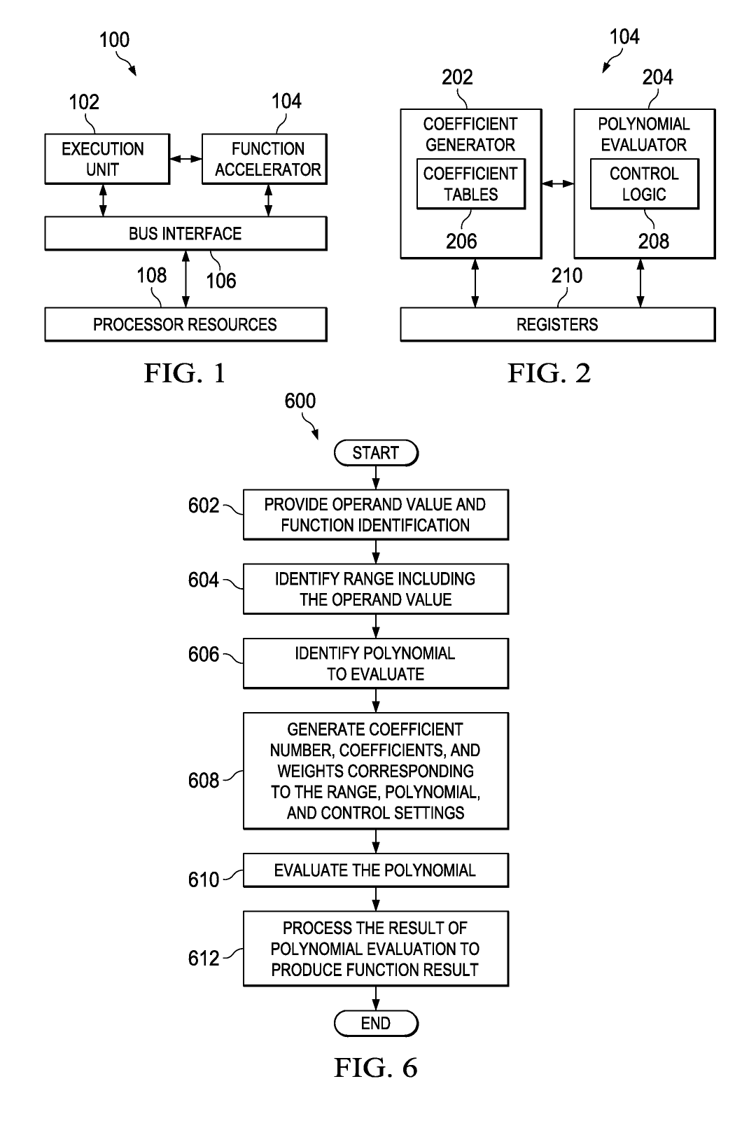

FIG. 1 shows a block diagram of a processor 100 in accordance with various embodiments. The processor 100 executes instructions retrieved from a computer readable storage device, such as a volatile or non-volatile memory device. The instructions may include a complex instruction that directs the processor 100 to evaluate a function such as a trigonometric, exponential, logarithmic, root, or other complex function.

The processor 100 includes an execution unit 102 and a function accelerator 104. The execution unit 102 may include an arithmetic logic unit, shifter, multiplier and/or other data manipulation circuitry applied in instruction execution. Embodiments of the processor 100 may include more than one execution unit. The function accelerator 104 is coupled to the execution unit 102. The function accelerator 104 applies polynomial evaluation to estimate a specified function at a designated input value.

The function accelerator 104 provides improved function evaluation efficiency by selecting the number and values of coefficients applied in the polynomial based on the input value. Accordingly, the function accelerator 104 may apply different numbers of coefficients and/or coefficient values in different ranges of the function, where the number and/or values of the coefficients are optimized for each range. In some embodiments, the function accelerator 104 may execute complex instructions that specify the function to be evaluated.

In some embodiments, the execution unit 102 and the function accelerator 104 may be part of and embodied in a single processor core. In other embodiments, the execution unit 102 is part of a processor core, and the function accelerator 104 is separate from the processor core.

The bus interface 106 connects the execution unit 102 and, the function accelerator 104 in some embodiments, to other components of the processor 100 and/or to components external to the processor 100 via a communication structure, such as a data and address bus. In some embodiments, the function accelerator 104 may be coupled to the execution unit 102 via the bus interface 106.

The processor resources 108 include peripheral devices, such as memories, input/output ports, timers, communication subsystems, etc. that the execution unit 102, and the function accelerator in some embodiments, access via the bus interface 106.

FIG. 2 shows block diagram of a function accelerator 104 in accordance with various embodiments. The function accelerator 104 includes a coefficient generator 202, a polynomial evaluator 204, and registers 210. The registers 210 are coupled to the coefficient generator 202 and the polynomial evaluator 204, and provide storage for coefficients, input values, results of function and polynomial evaluation, etc.

The coefficient generator 202 provides the coefficients of the polynomial to be evaluated to estimate the value of the function. The coefficient generator 202 includes one or more coefficient tables 206. The coefficient tables 206 may store coefficient values or may produce coefficient values by operation of logic (e.g., combinatorially). The coefficient generator 202 produces coefficients for the polynomial based on the function to be evaluated, and the function input value. Accordingly, the coefficient tables 206 may include one or more tables corresponding to each function that can be evaluated by the function accelerator 104. The coefficient tables 206 may comprise volatile and/or non-volatile coefficient storage (e.g., registers, random access memory, FLASH memory, read only memory, etc.) and coefficient values may be programmed into the tables 206 by execution of the processor 100 (at run-time) or at manufacture of the processor 100.

The coefficient generator 202 partitions the range of input values of a function into a plurality of sub-ranges, and may generate different values for each coefficient in each sub-range. For example, for a given function, the coefficient generator may generate a first set of coefficient values for an input value in a first sub-range of the function, and generate different coefficient values for an input value in a second sub-range of the function. The number of input values encompassed by the first sub-range may differ from the number of input values encompassed by the second sub-range. The size of each sub-range may be selected in accordance with the coefficients applied to estimate the function in the sub-range.

Similarly, the coefficient generator 202 may generate a different number of coefficients for each range, or at least some ranges, of the function. For example, in ranges where the function is more linear, the coefficient generator 202 may generate few coefficients, and in more non-linear ranges of the function the coefficient generator 202 may generate more coefficients. Thus, the coefficient generator 202 subdivides the range of the function into a number of sub-ranges suitable to estimate the function while providing for each sub-range a number and value of coefficients selected to estimate the function in the sub-range. The number and/or value of the coefficients may be adaptively selected based on, for example, accuracy and/or energy constraints.

The polynomial evaluator 204 receives the coefficients provided by the coefficient generator 202, and applies the coefficients to estimate the function at the input value. The polynomial evaluator 204 includes control logic 208. The control logic 208 sequences the polynomial evaluator 204 through the arithmetic operations (multiplications, additions, etc.) applied to estimate the function. The polynomial evaluator 204 may include adders, multipliers, shifters and other computational logic needed to evaluate the polynomial. In some embodiments, the polynomial evaluator 204 may apply computational logic embodied in other execution units of the processor 100 to compute the polynomial result.

In some embodiments, the polynomial evaluator 204 may employ fractional arithmetic (i.e., fixed point processing) to evaluate the polynomial. The input value and result of function evaluation may be provided in other numeric formats (e.g., floating point format), and the polynomial evaluator 204 may provide conversion between numeric formats as needed. Some embodiments of the polynomial evaluator may employ floating point computation.

For symmetrical functions, such as sine, cosine, etc., the polynomial evaluator 204 may adjust the input value to allow for evaluation of the function in a predetermined sub-range. For example, input values for trigonometric functions may be adjusted to fall in a sub-range of 0 to

$$\frac{π}{2}$$

and the result of evaluation correspondingly adjusted to produce a result in accordance with the input value. In some embodiments, the input values for trigonometric functions (e.g., sine or cosine) may be restricted, by adjustment operations in the function accelerator 104, to a range of 0 to

$$\frac{π}{4} ,$$

and polynomial evaluation in the range of 0 to

$$\frac{π}{4}$$

may provide more accurate results than evaluation over 0 to

$$\frac{π}{2} .$$

For example, requests to evaluate the sine function may apply a sine approximation polynomial between 0 to

$$\frac{π}{4}$$

and may apply a cosine approximation polynomial in the range of 0 to

$$\frac{π}{4}$$

to evaluate sine function request input values falling between

$$\frac{π}{4}$$

$$and$$

$$\frac{π}{2} .$$

The polynomial evaluator 204 may also scale the input value to ensure that the input value falls in a magnitude range suitable for accurate computation.

For specified values of a function, the polynomial evaluator 204 may store result values to be provided rather than compute the result. For example, result values for trigonometric functions at input values or 0,

$$\frac{π}{4} , \frac{π}{2} ,$$

etc. may be provided from storage rather than computed.

The control logic 208 may include state machines that provide the polynomial sequencing. For example, the control logic 208 may include a state machine for sequencing of each different polynomial applied to estimate a function. The state machines may specify which terms of a polynomial are applied. One polynomial state machine may apply odd numbered terms, another may apply even numbered terms, and yet another may apply terms as specified. In some embodiments, the control logic 208 may sequence polynomial evaluation in accordance with Homer's method. Polynomial sequencing (e.g., via state machine), in addition to other control functions of the logic 208, may be programmed at run-time or at manufacture of the processor 100.

In addition to sequencing computation of the polynomial, the control logic 208 may select which polynomial is to be applied to evaluate the function. In some cases, to evaluate a given function, the control logic 208 may select a polynomial generally applied to evaluate a different function. For example, to evaluate a sine function at an input value in a predetermined sub-range

$$( e . g . , \frac{π}{4} to \frac{π}{2} ) ,$$

the control logic 208 may select to evaluate a cosine function and further process (square and subtract from one) the result of cosine evaluation to produce the sine function result. Thus, the control logic 208 may select a polynomial to evaluate based on the requested function and the function input value. The control logic 208 may provide an indication of the selected polynomial to the coefficient generator 202. Such polynomial selection information may be provided in a table of the control logic. Alternatively, polynomial selection may be provided by the coefficient tables 206 or other circuitry of the function accelerator 104 and communicated to the control logic 208.

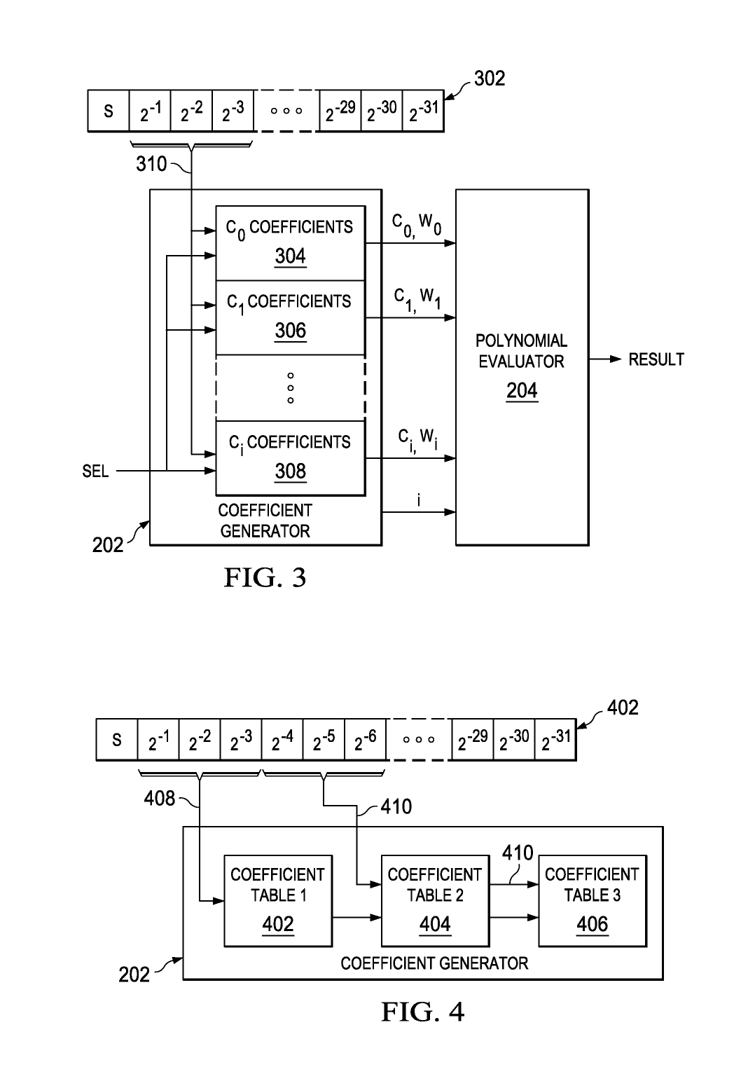

FIG. 3 shows coefficient generation in the function accelerator 104 in accordance with various embodiments. In FIG. 3, the coefficient generator 202 selects coefficients for a polynomial based on the value of the three most significant bits (2⁻¹, 2⁻², and 2⁻³) 310 of the input value 302. In some embodiments, a different number of bits and/or different bits of the input value 302 may be used to select the coefficients. The three bits 310 of value 302 considered in FIG. 3 may represent eight sub-ranges of the function being evaluated, or in some embodiments values of the three bit field 310 may be combined to represent fewer than eight sub-ranges of the function. For example, values 3-5 of the field 310 may represent a single sub-range for coefficient generation, and each of values 0, 1, 2, 6, 7 and 8 may represent different distinct sub-ranges for coefficient generation.

The coefficient generator 202 includes i coefficient tables (304, 306, 308) where each coefficient table produces a coefficient for a term of the polynomial. The coefficient generator 202 may produce different coefficient values and a different number of coefficients based on the value of the three most significant bits of value 302. The number of coefficients (i) and the coefficient values (c) are provided to the polynomial evaluator 204.

The coefficient generator 202 may also generate weight values (w) that are to be applied in conjunction with the coefficients. In some embodiments, a weight value may be provided in conjunction with each coefficient value. The weight value may be applied by the polynomial evaluator 204 to scale a result of multiplication by the associated coefficient to, for example, keep the result within a desired range. The weight values may be positive or negative powers of 2 to allow for application by shifting. The weight values may be applied at various stages of the polynomial evaluation, e.g., immediately after application of a coefficient, or later in the polynomial computation.

The coefficient generator 202 may also select the coefficient number, coefficient values, and weight values based on a select signal (SEL) or selection information provided to the coefficient generator 202. The selection information may specify a goal of function evaluation to be provided for in the selection of coefficients. For example, in support of a goal of minimizing energy consumption, the coefficient generator 202 may provide fewer coefficients and/or sacrifice result accuracy to some degree. Similarly, to maximize result accuracy, the coefficient generator 202 may provide more coefficients, thereby requiring a higher level of power consumption to produce a result.

Additionally, embodiments may adjust accuracy versus energy consumption by selecting the width of the coefficients and term calculation logic applied to evaluate a polynomial. For example, a smaller computation width (e.g., 32 bits) can be selected and applied to reduce energy consumption, while a larger computation width (e.g., 64 bits) can be selected and applied to increase result accuracy. Such selection may be realized via a select signal or selection information provided to the coefficient generator 202 and/or the polynomial evaluator 204.

FIG. 4 shows block diagram of the coefficient generator 202 that includes multiple cascaded coefficient tables in accordance with various embodiments. The coefficient generator 202 may employ such an arrangement of coefficient tables if, for example, a particular sub-range of a function is to further partitioned. In FIG. 4, the coefficient generator 202 includes a number of cascaded coefficient tables 402, 404, 406. Coefficient table 402 is arranged to select coefficients, weights, etc. based on the value of the uppermost three bits (2⁻¹, 2⁻², and 2⁻³) 408 of the input value 402 at which the function is to be evaluated. Thus, the coefficient table 402 may define up to seven sub-ranges of the function, and provide unique coefficients that are optimized to improve estimation accuracy for each sub-range.

In the coefficient generator 202 of FIG. 4, at least one of the sub-ranges defined by table 202 is further partitioned into smaller sub-ranges by coefficient table 404. Coefficient table 404 is coupled to coefficient table 402 and is arranged to select coefficients, weights, etc. based on a lower three bits (2⁻⁴, 2⁻⁵, and 2⁻⁶) 410 of the input value 402 when table 402 indicates that the input value 402 falls into the sub-range corresponding to table 404. A third coefficient table 406 is arranged to select coefficients, weights, etc. based on bits 410 and trigger signals provided by coefficient table 404. For example, the coefficient table 406 may provide coefficients for one or more of the sub-ranges defined by of bits 410. By dividing the coefficients across cascaded tables in this manner, embodiments may reduce the overall amount of storage required in cases where the function is partitioned in to fewer than the maximum number of sub-ranges supported by the total number of bits of the fields 408, 410.

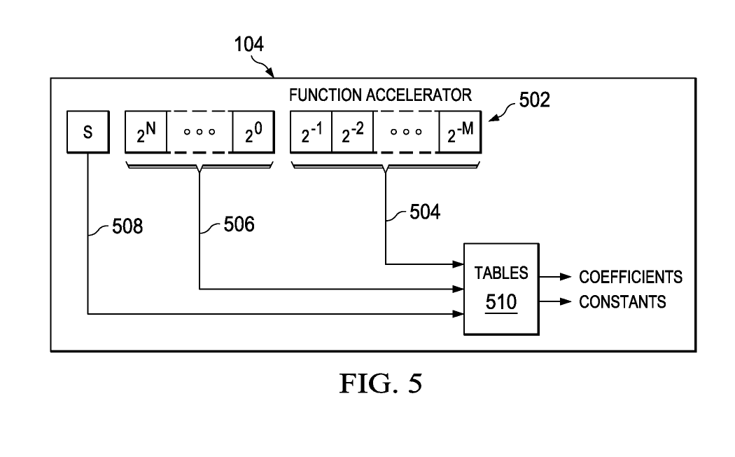

FIG. 5 shows use of various fields of a function input value 502 in a function accelerator 104 in accordance with various embodiments. The tables 510 may include the coefficient tables 206, tables providing constants for use in function evaluation, and/or other tables applied by the function accelerator 104. The tables 510 may be accessed using various portions of the input value 502. In some embodiments of the function accelerator 104, the fractional portion 504 of the input value 502, or a portion thereof, may used to access a table 510 to provide coefficients, constants or other values for function evaluation.

The function accelerator 104 may also apply the sign flag 508 of the input value 502 to access the tables 502. For example, the sign flag 508 may be applied in conjunction with the fractional portion 504 of the input value 502 to generate polynomial coefficients. The function accelerator may also apply the sign flag 508 to select the polynomial to be evaluated and/or to determine whether the result of function evaluation produces an imaginary number.

Embodiments of the function accelerator 104 may also apply a non-fractional portion 506 of the input value 502 to access tables 510. The non-fractional portion 506 may be an exponent value (e.g., of an IEEE 754 floating point value), an integer portion of a fixed point input value 502, etc. The non-fractional portion 506 may be applied to retrieve constants, coefficients, etc. from the tables 510.

FIG. 6 shows a flow diagram for a method 600 for evaluating a function in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 600 can be implemented as instructions stored in a computer readable medium and executed by the processor 100.

In block 602, the processor 100 provides to the function accelerator 104, an indication of a function to be evaluated and an operand value at which the indicated function is to be evaluated. For example, the execution unit 102 may pass an instruction defining the function and operand to the function accelerator 104. Alternatively, the execution unit 102 may load a function specification and/or operand into registers accessible by the function accelerator 104.

In block 604, the function accelerator 104 identifies a sub-range of the function encompassing the operand value. The function accelerator 104 may divide the range of the function into any number of sub-ranges and provide different coefficients for each sub-range. The sub-ranges may each encompass a different number of operand values.

In block 606, the function accelerator 104 identifies the polynomial to be evaluated for the indicated function and operand value. Different polynomials may be provided to evaluate different sub-ranges of a function. For some sub-ranges of a given function, a polynomial generally applied to evaluate a different function may be applied to evaluate the given function.

In block 608, the function accelerator 104 generates a number of coefficients, coefficient values, and weight values to be applied in the selected polynomial. The number of coefficients, coefficient values, and weight values may be selected based on the sub-range of the function in which the operand value falls and the polynomial selected for evaluation. Control information may also be provided to the function accelerator 104 that affects coefficient selection. For example, control information received by the function accelerator 104 may cause generation of fewer coefficients to reduce polynomial computation time and energy consumption, or cause generation of more coefficients to increase result accuracy.

In block 610, the function accelerator 104 evaluates the selected polynomial using the generated coefficient and weight values. The computation of the polynomial may be sequenced in accordance with Homer's method in some embodiments.

In block 612, the function accelerator 104 applies to the result of polynomial evaluation any further processing needed to produce the result of the function. The result of the function may be provided to the execution unit 102 or stored for access by the execution 102 or other components of the processor 100.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A processor, comprising:
a function accelerator unit configured to evaluate a mathematical function, and comprising:
a coefficient generator configured to generate coefficients for a polynomial evaluated to produce a solution to the function, wherein the coefficient generator varies values of the coefficients based on an input value at which the function is to be evaluated; and
a polynomial evaluator configured to apply the coefficients provided by the coefficient generator to evaluate the polynomial at the input value.

2. The processor of claim 1, wherein the coefficient generator is configured to determine a number of coefficients to be applied in the polynomial; wherein the coefficient generator varies the number of coefficients based on the input value at which the function is to be evaluated.

3. The processor of claim 1, wherein the coefficient generator is configured to generate the coefficients based on a value of a predetermined number of most significant bits of the input value.

4. The processor claim 1, wherein the coefficient generator comprises a plurality of cascaded coefficient tables each of which is configured to generate coefficients based on a different set of bits of the input value.

5. The processor of claim 1, wherein the coefficient generator is configured to generate a plurality of sets of different coefficients with respect to the function, and each of the sets of coefficients is applicable to a different range of the input value.

6. The processor claim 5, wherein range size to which a given one of the sets of coefficients is applicable is different from range size to which a different one of the sets of coefficients is applicable.

7. The processor of claim 1, wherein the coefficient generator is configured to provide a scaling factor for use with a coefficient; and the polynomial evaluator is configured to apply the scaling factor in conjunction with the coefficient to evaluate the polynomial.

8. The processor of claim 1, wherein the coefficient generator comprises a plurality of coefficient tables for use in evaluating a function, and the coefficient generator is configured to select which of the coefficient tables to use for coefficient generation based on a control signal provided to the coefficient generator.

9. The processor of claim 1, wherein the function accelerator unit is configured to solve a plurality of different functions, and for a given function, the coefficient generator is configured to generate, based on the input value, coefficients applicable to a different function to solve the given function.

10. The processor of claim 9, wherein the polynomial evaluator is configured to produce a result of evaluation of the polynomial for the different function, and further process the result to produce a result for the given function.

11. The processor of claim 1, wherein the polynomial evaluator is configured to determine, based on the function, which terms of the polynomial are to be computed; and the polynomial evaluator is configured to skip, based on the function, computation of at least one term of the polynomial.

12. The processor claim 1, wherein the coefficient values, input value range per coefficient set, number of coefficients sets, number of coefficients applied, and scaling factor for scaling a coefficient are programmable at run-time of the processor.

13. A method for accelerating function processing, comprising:
providing, to a hardware accelerator, a designation of a function to be evaluated, and an operand value at which the function is to be evaluated;
generating, by the hardware accelerator, coefficients for a polynomial to be evaluated to produce a solution to the function, and varying values of the coefficients based on the operand value; and
applying the coefficients to evaluate the polynomial at the operand value.

14. The method of claim 13, further comprising:
determining, by the hardware accelerator, a number of coefficients to be applied in the polynomial; and
varying the number of coefficients based on the operand value at which the function is to be evaluated.

15. The method of claim 13, further comprising generating the coefficients based on the value of a predetermined number of most significant bits of the operand value

16. The method of claim 13, further comprising selecting from a plurality of sets of different coefficients with respect to the function; wherein:
each of the sets of coefficients is applicable to a different range of the operand value; and
at least some of the different ranges of the operand value are optionally of different size.

17. The method of claim 13, further comprising:
generating a scaling factor for use with a coefficient; and
applying the scaling factor in conjunction with the coefficient to evaluate the polynomial.

18. The method of claim 13, wherein generating the coefficients comprises selecting the coefficients based on selection of one of minimization of energy use and result accuracy as a computational goal.

19. The method of claim 13, further comprising:
generating, for a given function, based on the operand value, coefficients applicable to a different function to solve the given function; and
producing a result of evaluation of the polynomial for the different function; and
processing the result to produce a result for the given function.

20. The method of claim 13, further comprising:
determining, based on the function, which terms of the polynomial are to be computed; and
skipping, based on the function, computation of at least one term of the polynomial.

21. A function acceleration circuit, comprising:
a coefficient generator configured to:
generate coefficients for a polynomial to be evaluated to produce a solution to a function, wherein the coefficient generator varies values of the coefficients based on an input value at which the function is to be evaluated;
determine a number of coefficients to be applied in the polynomial; wherein the coefficient generator varies the number of coefficients based on the input value at which the function is to be evaluated; and
provide a scaling factor for use with at least one of the coefficients; and
a polynomial evaluator configured to:
determine, based on the function, which terms of the polynomial are to be computed and which terms, between terms to be computed, are to be omitted; and
apply the coefficients and the scaling factor provided by the coefficient generator to evaluate the polynomial at the input value.

22. The function acceleration circuit of claim 21, wherein the coefficient generator is configured to generate a plurality of sets of different coefficients with respect to the function, and each of the sets of coefficients is applicable to a different range of the input value; and wherein range size to which a given one of the sets of coefficients is applicable is different from range size to which a different one of the sets of coefficients is applicable.

23. The function acceleration circuit of claim 21, wherein the coefficient generator comprises a plurality of coefficient tables for use in evaluating a function, and the coefficient generator is configured to select which of the coefficient tables to use for coefficient generation based on whether energy efficiency or result accuracy is selected.

24. The function acceleration circuit of claim 21, wherein the coefficient generator is configured to generate for a given function, based on the input value, coefficients applicable to different function; and the polynomial evaluator is configured to produce a result of evaluation of the polynomial for the different function, and further process the result to produce a result for the given function.
